(19) United States
(12) Patent Application Publication
(10) Pub. No.: US 2026/0223207 A1
(43) Pub. Date: Jul. 30, 2026

(54) PREDICTIVE MANAGEMENT OF BANDWIDTH CONSUMPTION AND DYNAMIC SATELLITE CONNECTIVITY MANAGEMENT

(71) Applicant: GOGO BUSINESS AVIATION LLC, Broomfield, CO (US)

(72) Inventors: Hind Mukhtar, Stittsville (CA); Raymond Schaub, III, Satellite Beach, FL (US); Chuan Jiang, Kanata (CA); Stephen Mercer, Nepean (CA); Melike Erol-Kantarci, Ottawa (CA)

(21) Appl. No.: 19/454,067

(22) Filed: Jan. 20, 2026

Related U.S. Application Data
(60) Provisional application No. 63/749,478, filed on Jan. 24, 2025.

(51) Int. Cl. H04W 76/10

(52) U.S. Cl. CPC H04W 76/10

(57) ABSTRACT

A system and method are disclosed to efficiently utilize the satellite bandwidth consumed by an air to ground service application that collects data for support and analysis of an on-wing Line Replacement Unit (LRU). The method statistically analyzes the data rates for air to ground traffic and dynamically modifies established bandwidth caps to minimize the available bandwidth needed for groundside reporting. In addition, the system and method comprise a framework to forecast the health of network connectivity. This system adeptly identifies and predicts faults or events in the avionics communication system during flights. Additionally, it leverages the forecasted network performance to implement actions that enhance the overall user experience.

### CROSS-REFERENCE TO RELATED APPLICATIONS AND INCORPORATION BY REFERENCE

This Provisional Patent Application claims priority to U.S. Provisional Ser. No. 63/749,478, entitled “PREDICTIVE MANAGEMENT OF BANDWIDTH CONSUMPTION AND DYNAMIC SATELLITE CONNECTIVITY MANAGEMENT” filed in the United States Patent and Trademark Office (USPTO) on Jan. 24, 2025, which is incorporated by reference herein in its entirety.

### STATEMENT REGARDING FEDERALLY SPONSORED RESEARCH OR DEVELOPMENT

Not applicable.

### FIELD OF THE INVENTION

The field of the invention is a system and method for forecasting the state of connectivity of a data network. More specifically, the invention, in embodiments, is a system and method for statistically analyzing the data rates of air to ground communications networks, and dynamically modifying established bandwidth caps to minimize the available bandwidth needed for groundside reporting. Aspects of the invention may also forecast the health of network connectivity. The system and method accurately identifies and predicts faults or events in an avionics communication system during flights. Additionally, aspects of the invention may leverage the forecasted network performance to implement actions that enhance the overall user experience.

### BACKGROUND

Aircraft datalink connection technologies are critical components in modem aviation, providing a means for communication and data exchange between aircraft and ground systems, as well as between aircraft. These technologies enhance the efficiency, safety, and situational awareness of flight operations.

With regard to aircraft datalink systems, typically, datalink monitoring information historically has only been available/published by the FAA two times per year. Under this legacy approach, flight operators were required to create an account with a website-based service such as fans-era.com, become a member of the Performance-Based Communication and Surveillance (PBCS) Charter and review datalink performance postings two times per year. For many business aviation flight departments, there has not been enough data accumulated over a six-month period to have a sufficient sample set of data to calculate accurate aircraft datalink performance numbers. This is a significant drawback of this legacy approach to datalink monitoring.

Current mandates by most aviation regulatory bodies require all aircraft operators to monitor their aircraft's datalink communication and surveillance performance as defined by International Civil Aviation Organization (ICAO) Standards and Recommended Practices; this is known as PBCS monitoring, and is a critical aspect of modem air traffic management systems, ensuring that the communication and surveillance capabilities of aircraft meet the required performance standards for safe and efficient operations.

PBCS establishes operational requirements for communication and surveillance performance in specific airspace environments. To comply with these requirements, most non-airline operators must rely on data compiled by an industry working group (FANS-CRA) to observe their own performance. This data is only compiled in six-month intervals, thus making timely identification of performance issues difficult. The data compiled in these reports also does not reflect all air traffic control regions which support the datalink service sets on which the performance is measured. The timing of when this data is made available, its lack of comprehensiveness and the operational impact creates a strong argument for the need of real-time or near real-time and accurate monitoring of datalink communication and surveillance performance metrics.

Satellite communication (SATCOM) systems use space-borne satellites to provide voice and data communications to aircraft. Currently, a single satellite beam can provide service to multiple aircraft end points. However, there is no method currently established for each individual end point to know how many aircraft end points are being serviced by the satellite beam, or how much data/bandwidth each SATCOM aircraft endpoint is consuming. Thus, there is a need to minimize and be able to control or limit the bandwidth consumption at the aircraft endpoint level.

Static bandwidth caps are a conventional method used to control the bandwidth consumption of SATCOM systems by imposing fixed limits on the data transfer rates or total data usage by a specific endpoint, user or application over a specific period. These caps are essential for managing the limited and expensive bandwidth resources available on satellite networks.

For example, a data rate cap can be used to set a maximum data transfer rate (e.g., 512 Kilobytes pers second (KBps), 1 Megabytes per second (MBps), and so on) for endpoints, users, and/or applications, ensuring that the bandwidth consumption does not exceed the specified rate.

As another example, a data usage cap can be used to set a limit on the total amount of data that can be transmitted or received over a specific period of days, weeks, months or other period of time (e.g., 5 gigabytes (GB) per month). Once this limit is reached, additional data usage may be throttled or blocked altogether.

The above are two examples of the use of static bandwidth caps for controlling the bandwidth consumption, however they are unable to account for real-time usage of a data link. An objective of the present invention is to analyze and understand the bandwidth needs of each air to ground services data user, to limit the bandwidth for each user accordingly, and thereby maximize the bandwidth available to all endpoints using the satellite link.

Typically, data service providers establish a set of static bandwidth caps at a percentage of the theoretical capacity of active satellite link bandwidth. When these bandwidth caps are reached, some or all air to ground data communication is postponed until data rates drop below caps. A limitation of this method is that bandwidth caps can only be chosen in advance based on the theoretical limits of the satellite link technology in question, and cannot anticipate real-time network traffic bandwidth needs. When bandwidth rates are much lower than the caps, these caps are not effective in managing bursty or dynamically changing data rates.

Typically, flight plan options may be provided to a customer who desires data connectivity during a flight. The flight plan options may be configured, at least in part, based on the needed data bandwidth performance during the flight. In response to the established data bandwidth needs, the aircraft would then follow a selected predefined flight plan during flight placing the aircraft in communication with SATCOM link that provide the required data bandwidth during the flight. If data connectivity issues occur during the flight, the standard procedure is to contact communication system provider product support personnel. Product support personnel have the capability to access real-time data communication logs provided by the link communication equipment, which may be in the form of Line Replaceable Units (“LRUs”), on the aircraft. These logs aid in understanding and troubleshooting data link connectivity issues. Product support may contact the customer during the flight if upcoming problems are identified, or predicted, using the real-time logs.

Problems in data link performance that cannot be identified during the flight may be analyzed post-flight. The product support team and subject matter experts may be able to analyze data link logs for the specific times when issues in data link performance occurred with the goal of identifying the root cause of the problem. Findings from post-flight analysis may then be used for continuous improvement initiatives. This may involve implementing measures to prevent the recurrence of the same problem in the future. However, this post-flight analysis does not assist the current in-flight data consumer, and this is of no benefit to the in-flight user experiencing current data communication bandwidth or connectivity issues.

Therefore, what is needed in the art are systems and methods for monitoring aircraft data link performance in real-time, or near real-time, in order to effectively manage bursty or dynamically changing rates. Furthermore, what is needed in the art is the ability to forecast the health of a data network and predict faults or events in the avionics communication system during flights.

### SUMMARY

An object of the invention provides a method for predictively managing data/bandwidth consumption of air to ground services. In a non-limiting embodiment, the present invention is enabled by looking at a short sequence of the current session history of bandwidth data rates and data burst rates and determining if they significantly differ from the current bandwidth cap settings. If so, the current operating caps for the session will be lowered or raised, according to the prevailing rates, subject to an absolute cap of either the configured cap for the session, or the default cap, if no alternative configured cap is available. In some embodiments, this technique is not applied across sessions. In other embodiments, if the caps are disabled, then this technique will not apply.

The invention has real-time (or near real-time) monitoring capabilities for collecting data rates for air to ground traffic and dynamically modifies established bandwidth caps to minimize the available bandwidth needed for groundside reporting.

The invention's novel method uses coding rules to monitor and log the necessary data points from live data feeds, store the data and make calculations without reliance on third-party entities or processes to create and disseminate datalink bandwidth caps.

The invention improves over conventional static bandwidth caps methodologies in that it identifies when the data link service traffic requires less bandwidth and more efficiently utilizes that bandwidth. Bandwidth bursts are more tightly constrained and traffic is more tightly smoothed out by lower caps on the bandwidth rate.

Furthermore, it is an object of the present invention to identify and predict faults or events in the avionics communication system during flights. The invention leverages the forecasted network performance to implement actions that enhance the overall user experience. The invention utilizes an artificial intelligence/machine learning based model that is trained through historical data. Implementation of embodiments of the invention can be summarized, generally, in three (3) phases-pre-flight, in-flight, and post-flight.

Phase 1 is the pre-flight phase, in which the system predicts the performance of a chosen network based on a desired flight plan. The flight plan can then be adapted to provide the optimal network performance. The network performance is determined through a scoring algorithm that combines both the network's quality of service (QoS) and the user's experience (QoE).

Phase 2 is implemented in-flight, in which the system predicts potential events or faults, in real-time (or near real-time), that could degrade network performance. Non-limiting examples of potential events or faults include expected outages, handovers, congestion, equipment failure, and more. The system can proactively take corrective measures to either rectify the fault or alert the customer about impending outages that cannot be eliminated. For instance, when an aircraft (e.g., vehicle) is equipped with various high-speed data services, the system can determine the optimal network at the given time given the users usage trends and experience, as well as the network's quality of service. The system can also send notifications to customers to alert them of upcoming outages or handovers. The system of the invention may also assist with handover decisions to create a more seamless handover experience and reduce switch times.

Phase 3 occurs post-flight, in which the system conducts an analysis categorizing all encountered faults or events. Additionally, it identifies any anomalies-faults or events that have not previously occurred. This post-flight assessment contributes to a comprehensive understanding of system behavior, aiding in ongoing improvement efforts and providing valuable insights for future flights. Examples of events and faults include, but are not limited to, congestion, blockage, overheating issues, beam switches, satellite switches, RF performance issues, pipeline saturation, dynamically changing flight conditions, etc.

Implementation of the system and method of the present invention is accomplished through the application of Artificial Intelligence (AI)/Machine-Leaming (ML) algorithms. These algorithms undergo training using accumulated LRU and historical flight data spanning several years, such as positional data, aircraft dynamics, equipment controls & status, and QoS & QoE indicators. The approach encompasses a combination of algorithms, including clustering, recurrent neural networks and reinforcement learning, for scoring time series predictions and optimization. Additionally, cutting-edge technologies such as transformer and sequence-to-sequence networks are employed for real-time detection of faults or events.

The invention provides for a comprehensive approach, spanning the entirety of a user's experience, encompassing pre-flight, during flight, and post-flight phases. Unlike conventional systems focused solely on outage prediction, this invention introduces a scoring system. By merging Quality of Service (QoS) and Quality of Experience (QoE) factors, the system determines an avionic communication system's performance throughout the flight, anticipating potential degradation in network connectivity rather than just predicting outages. The system extends its capabilities to classify events and faults occurring during the flight and identifies anomalies-instances of faults or events that have not been observed before.

This depth of analysis aids in continuous product improvement initiatives. Furthermore, the system's ability to detect novel anomalies contributes significantly to root cause analysis, supporting the long-term enhancement of products and user experience. The proposed system goes beyond mere detection; it leverages the predicted performance to make informed decisions aimed at optimizing the overall user experience. This includes actions such as selecting a network aligning with specified QoS requirements, choosing the most connectivity-optimal flight route, rebooting equipment to address potential equipment failures, or adjusting transmission to prevent equipment overheating.

In embodiments, statistical analysis of the groundside service traffic establishes the de facto bandwidth needs of the service in real time and allows the system and method of the invention to reduce the bandwidth cap of each link to the levels needed for current traffic. In this way, embodiments of the invention minimize the data bandwidth reserved by the groundside service and maximize bandwidth available to the customer.

A key strength lies in the system's utilization of AI technology, which excels at discerning complex relationships. The trained model's resilience to shifts in trends is emphasized, as it continuously adapts and refines its understanding through ongoing training with fresh data. This innovation represents a proactive approach to avionic communication system management, promising an elevated and continuously improving user experience.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating exemplary embodiments of the invention and are not to be construed as limiting the invention. In the drawings:

FIG. 1 illustrates a single satellite beam capable of servicing multiple aircraft.

FIG. 2 illustrates conventional methodologies employing Static Bandwidth Caps.

FIG. 3 illustrates the use of Predictive Bandwidth Caps.

FIG. 4 is a process flowchart of an embodiment.

FIG. 5 illustrates an exemplary graphics user interface (GUI) for a user.

FIG. 6 illustrates a process flowchart of an embodiment.

FIG. 7 illustrates a process flowchart of an embodiment for predicting a flight score using a Recurrent Neural Network (RNN) forecasting model.

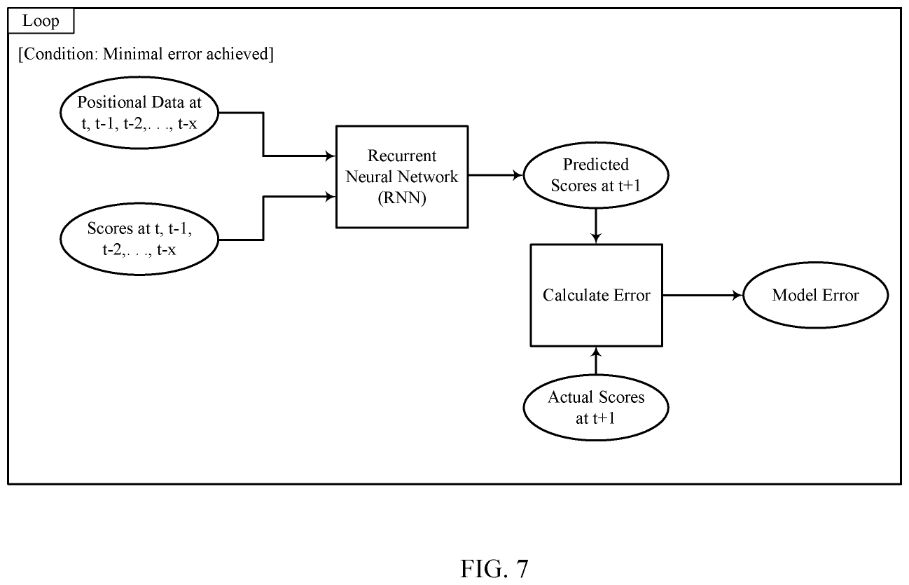

FIG. 8 illustrates a process flowchart of an embodiment for predicting a flight score using a K Nearest Neighbor (KNN) forecasting model.

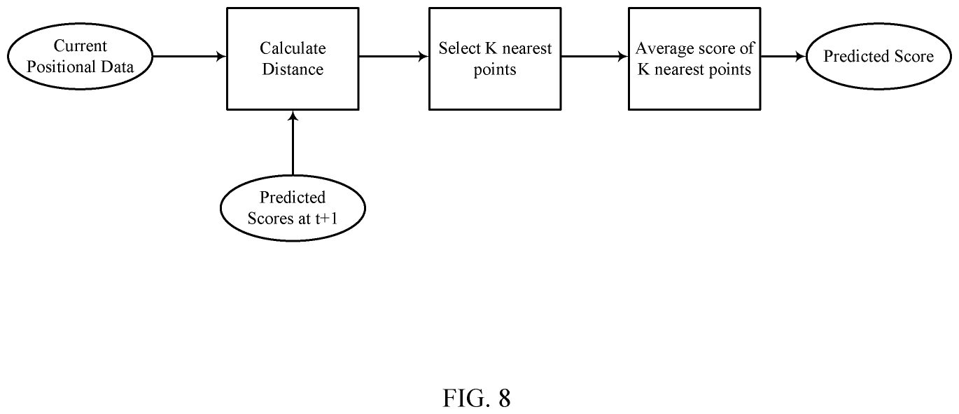

FIG. 9. illustrates a process flowchart of an embodiment for predicting a flight score using a Support Vector Regression (SVR) forecasting model.

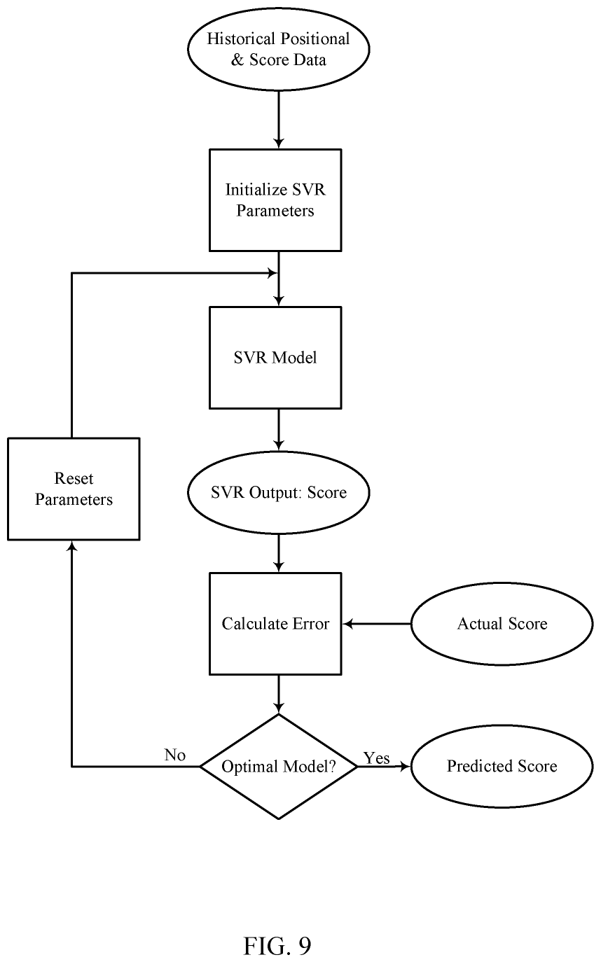

FIG. 10 illustrates a process flowchart of an embodiment for predicting an anomaly in real-time.

FIG. 11 illustrates a process flowchart of an embodiment for predicting an anomaly in using a Sequence to Sequence (SQ2SQ) forecasting model.

FIG. 12 illustrates a process flowchart of an embodiment for predicting an anomaly in using a VAEGAN forecasting model.

FIG. 13 illustrates a process flowchart of an embodiment for predicting an anomaly in using a Transformer forecasting model.

FIG. 14 illustrates a process flowchart of an embodiment for optimizing an aircraft's data throughput by performing an action.

FIG. 15 illustrates a process flowchart of an embodiment for optimizing an aircraft's data throughput by switching data networks.

FIG. 16 illustrates a process flowchart of an embodiment for optimizing an aircraft's data throughput using reinforcement learning.

FIG. 17A illustrates a process flowchart of an embodiment for generating a flight score.

FIG. 17B illustrates a process flowchart of an embodiment for generating a flight score.

FIG. 18 illustrates a process flowchart of an embodiment for generating a flight score using K means clustering.

FIG. 19 illustrates a process flowchart of an embodiment for post-flight event classification.

FIG. 20 illustrates a process flowchart of an embodiment for generating a flight score using a bagging ensemble learning classifier.

FIG. 21 illustrates a process flowchart of an embodiment for generating a flight score using a stacking ensemble learning classifier.

FIG. 22 illustrates a process flowchart of an embodiment for generating a flight score using a boosting ensemble learning classifier.

FIG. 23 illustrates a process flowchart of an embodiment for post-flight event classification.

FIG. 24 illustrates a process flowchart of an embodiment for post-flight event classification using a Recurrent Neural Network (RNN).

FIG. 25 illustrates a process flowchart of an embodiment for post-flight event classification using a K Nearest Neighbor (KNN) algorithm.

FIG. 26 illustrates a process flowchart of an embodiment for post-flight event classification using a Support Vector Classification.

FIG. 27 illustrates a process flowchart of an embodiment for post-flight event classification using transfer learning.

### DETAILED DESCRIPTION

The following disclosure provides a detailed description of the invention.

Although a detailed description as provided in this application contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

As used herein, “data rate” and “data transfer rate” may be used interchangeably and means the amount of data transmitted per unit of time. It is typically measured in bytes per second (Bps), kilobytes per second (KBps), megabytes per second (MBps), or gigabytes per second (GBps). A data rate indicates how fast data is being transferred from one point to another. Higher data rates mean more data can be sent or received in a given period. For example, if a network connection has a data rate of 100 MBps, it means it can theoretically transmit 100 megabytes of data every second. Data rates are concerned with the speed of data transmission.

As used herein, “bandwidth” refers to the maximum capacity of a communication channel to transmit data. It is the range of frequencies available for data transmission and is also typically measured in bytes per second (Bps), kilobytes per second (KBps), megabytes per second (MBps), or gigabytes per second (GBps). Bandwidth indicates the theoretical maximum data transfer rate of a network or communication channel. It defines how much data can be transmitted at once and is analogous to the width of a pipe through which data flows. Larger bandwidth allows for higher theoretical data rates. Bandwidth is concerned with a network's or channel's capacity to carry data.

As used herein, “ACP” means Actual Communication Performance.

As used herein, “ADS-B” means Automatic Dependent Surveillance-Broadcast. It is a technology used for tracking and monitoring aircraft which allows aircraft to broadcast their position, velocity, and other data to ATC and other aircraft.

As used herein, “Artificial Intelligence”, “AI”, “Machine Leaming” and “ML” each include within their meaning software code (defined below) to create models by training an algorithm to make predictions or decisions based on data. It encompasses a broad range of techniques that enable computers to learn from and make inferences based on data without being explicitly programmed for specific tasks. There are many types of machine learning techniques or algorithms, including linear regression, logistic regression, decision trees, random forest, support vector machines (SVMs), k-nearest neighbor (KNN), clustering and more. Each of these approaches is suited to different kinds of problems and data. Included within this definition are neural networks (or artificial neural networks). Neural networks are modeled after the human brain's structure and function. A neural network consists of interconnected layers of nodes (analogous to neurons) that work together to process and analyze complex data. Neural networks are well suited to tasks that involve identifying complex patterns and relationships in large amounts of data. Also included with this definition is supervised learning, which involves the use of labeled data sets to train algorithms to classify data or predict outcomes accurately. In supervised learning, humans pair each training example with an output label. The goal is for the model to learn the mapping between inputs and outputs in the training data, so it can predict the labels of new, unseen data. Still further, included in this definition is deep learning, which is a subset of machine learning that uses multilayered neural networks, called deep neural networks, that more closely simulate the complex decision-making power of the human brain. Deep neural networks include an input layer, at least three but usually hundreds of hidden layers, and an output layer, unlike neural networks used in classic machine learning models, which usually have only one or two hidden layers. These multiple layers enable unsupervised learning: they can automate the extraction of features from large, unlabeled and unstructured data sets, and make their own predictions about what the data represents.

As used herein, “ANSP” means Air Navigation Service Provider. An ANSP is a public or a private legal entity providing Air Navigation Services. It manages air traffic on behalf of a company, region or country. Depending on the specific mandate, an ANSP provides one or more of the following services to airspace users: Air traffic management (ATM); Communication navigation and surveillance systems (CNS); Meteorological service for air navigation (MET); Search and rescue (SAR); and Aeronautical Information Services/Aeronautical Information Management (AIS/AIM). These services are provided to air traffic during all phases of operations (approach, aerodrome and enroute). Air navigation service providers may be government departments, state-owned companies, or privatized organizations

As used herein, “ATC” means Air Traffic Control.

As used herein, “computer” and “server” may be used interchangeably and mean systems and devices that, alone or in combination, are operable to process and execute non-transitory computer readable and executable instructions. These computer readable and executable instructions typically reside in, or are stored on, non-transitory computer readable media this is in data communication with one or more microprocessors, firmware or controllers, such that the microprocessors, firmware or controllers are able to read and to execute such non-transitory computer readable and executable instructions. Such a medium may take many forms, including, but not limited to, non-volatile media and volatile media. The computer (or server) may comprise one or more microprocessors, firmware or controllers, such that the microprocessors. These microprocessors, firmware or controllers, such that the microprocessors may also be able write information to a non-transitory computer readable medium (or media), which may be, but is not necessarily, the same non-transitory computer readable media upon which is stored the non-transitory computer readable and executable instructions. The non-transitory computer readable media (or memory) may be any type of physical media, such as, for example and not by way of limitation, solid state memory, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. The microprocessors, firmware or controllers of the computer or server may also be in data communication with one or more transceivers, which may be operable to communicate data via wired or wireless data connections to one or more external or remote systems or data communication terminals. Wireless communication includes within its meaning Satellite, RF, and optical wireless communication. Further, in a computer or server, the microprocessors, firmware or controllers may also be in data communication with one or more physical displays, such as computer monitors or even television displays, and with mouse pads, keyboards. Thus, the computer is able to read and execute non-transitory computer readable and executable instructions, or software, that is stored in non-transitory computer readable media, and, by executing such non-transitory computer readable and executable instructions, carry out the functions and method steps of the invention.

As used herein, “CPDLC” means Controller-Pilot Data Link Communications, which is a means communication between an air traffic controller and a pilot, using datalink for ATC communications. This system enhances ATC by enabling text-based communication between controllers and pilots, reducing the need for voice communication and decreasing the chances of misunderstandings. See ICAO Doc 4444: PANS-ATM which is incorporated herein by reference.

As used herein “CSP” means Communication Services Provider. A Communication Services Provider may provide, among other technologies and services, Datalink Services, Radio Frequency communication services, ADS-B services, and/or Controller-Pilot Data Link Communications (CPDLC) services.

As used herein, “PBCS” means Performance-Based Communication and Surveillance, which provides objective operational criteria to evaluate different and emerging communication and surveillance technologies, intended for evolving air traffic management (ATM) operations. The PBCS also provides a framework in which all stakeholders (regulators, air traffic service providers, operators, communication service providers (CSP), and manufacturers) continue to collaborate in optimizing the use of available airspace while identifying and mitigating safety risks.

As used herein, “RF” means Radio Frequency and is generally used as characterizing data links that utilize propagating electromagnetic energy to provide data communications between communication terminals, at any frequency, including infrared, near infrared, and optical electromagnetic energy as well as any frequency of electromagnetic energy in any band or wavelength in the electromagnetic spectrum of frequencies. Thus, the communication links designated as “RF” links herein are not to be construed as being limited to any particular portion of the electromagnetic spectrum, and references to a specific frequency band, such as VHF (Very High Frequency) band are merely for illustrative purposes and not intend to be limiting.

As used herein, “Software” and “Software Code” means non-transitory computer-executable instructions, which may be stored in computer-readable media in communication with one or more processors, for carrying out the features and steps of the invention when the non-transitory computer-executable instructions are executed by the one or more processors.

As used herein, any data communications links may be either one-way or two-way data communication links, as may be required to carry out the features and functions of the invention

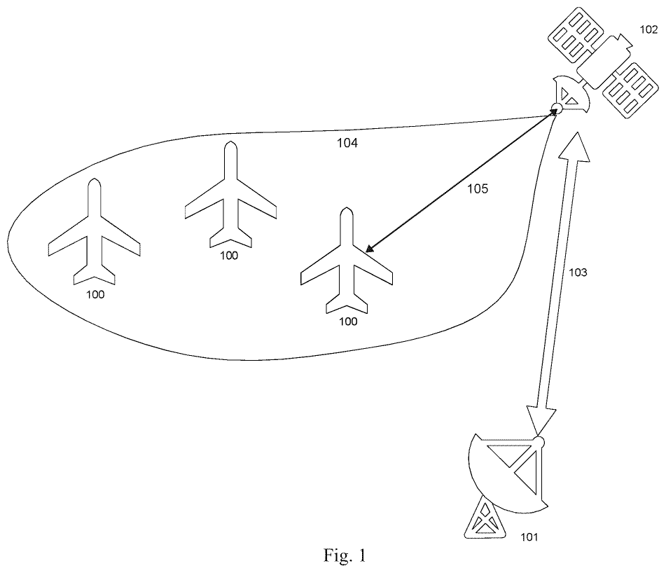

Referring now to FIG. 1, a non-limiting, exemplary system diagram of an in-flight aircraft datalink communication system is depicted. One or more endpoints (e.g. aircraft, vehicles) 100 may be in data communication with one or more ground-based systems 101 over one or more RF signal beams 104 having one or more wireless RF data links 105 via communications terminals 102, which may be but are not necessarily one or more overhead earth-orbiting satellites. Aircraft 100 may be, but is not necessarily, in flight. The one or more data communication terminals 102 may be in data communication, either directly or indirectly, with one or more data communications ground terminals 101 via data communication link 103. Data communications ground terminal 101 may in tum be in in data communication with one or more Communication Services Provider (CSP) data terminals (not shown) via one or more data communication links, which may be any data communication link or network, wired or wireless. Thus, a data communication path between aircraft 100 and one or more CSP data terminals is established via one or more data communication links. CSP data terminals may be in data communication with one or more data servers (not shown) via any data communication link or network, wired or wireless, which may be in tum in communication with CSP flight operations data center, or Network Operations Center (NOC) servers. Thus, a data link is established between aircraft 100 and CSP flight operations data center servers. For example, requests for data may be transmitted from flight operations data center servers to aircraft 100, and data from aircraft 100 may be communicated from aircraft 100 to flight operations data center servers.

In embodiments, an ATC ANSP data terminal (not shown) may be in communication with one or more CSP data terminals via a data communication link, which may be any data communication link or network, wired or wireless. Thus, a data link is established between ATC ANSP data terminal and aircraft 100, since the one or more CSP data terminals are in data communication with aircraft 100 via data communication links.

As can be appreciated by one of ordinary skill in the art, there could be any number of intervening gateways, buffers, modems, receivers, transmitters, servers, terminals, and other data communication equipment intervening in any of the data communication links described above.

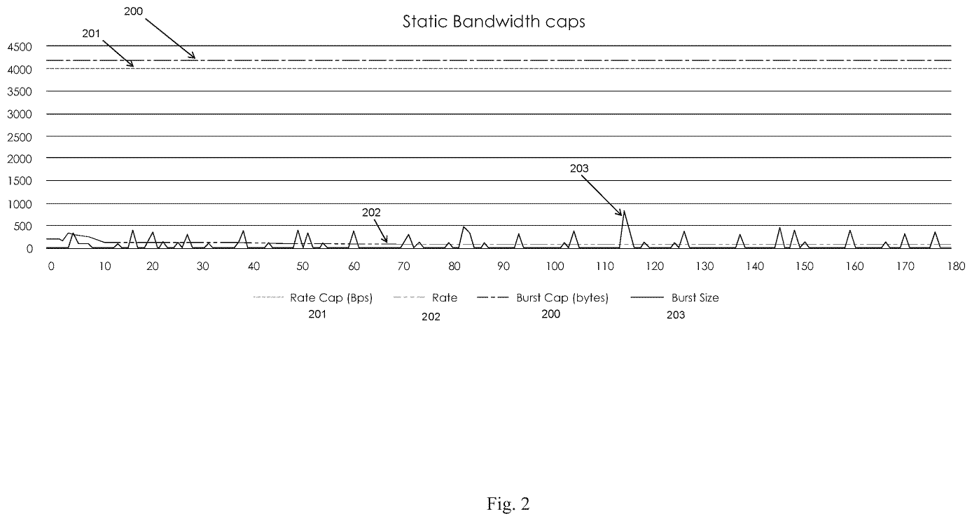

Referring now to FIG. 2, a chart illustrating conventional methodologies employing Static Bandwidth Caps. As can be seen, the Burst Cap 200 is set higher than the Rate Cap 201. A data burst 203 in the context of communications and networking refers to a short period during which data is transmitted at a significantly higher rate than the usual steady-state data rate 202. During a data burst 203 (typically triggered by specific events or conditions), data packets are sent at a higher rate, utilizing available bandwidth to quickly transmit a large volume of data. High-frequency data bursts can lead to network congestion if not properly managed. This can result in packet loss, increased latency, and reduced overall network performance. In SATCOM systems, data bursts may be used to efficiently transmit large amounts of data when the satellite link is available, optimizing the use of the limited and expensive satellite bandwidth.

The real-time data rate 202 and real-time burst rate 203 may be measured in real-time using embodiments disclosed in U.S. Provisional Application No. 63/551,970, entitled “SYSTEMS AND METHODS FOR AIRCRAFT DATALINK PERFORMANCE MONITORING”, which is incorporated by reference herein in its entirety.

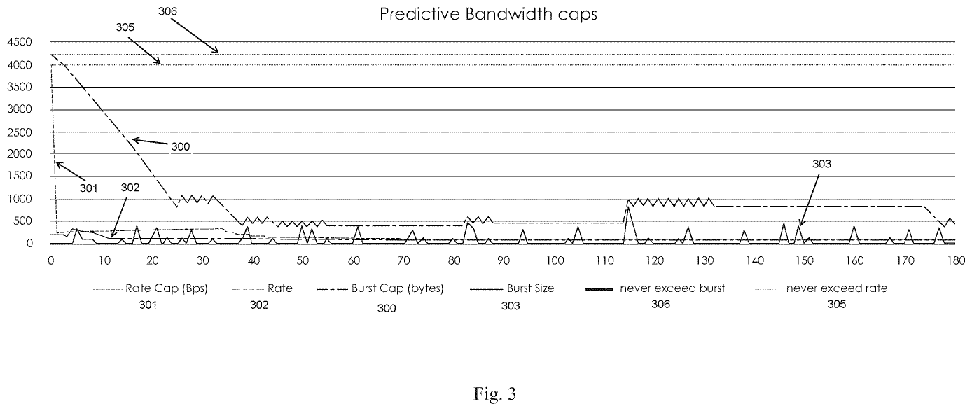

Referring now to FIG. 3, a chart illustrating predictive bandwidth caps implemented using an embodiment of the system and method of the present invention is depicted. Implementation of predictive bandwidth caps, as disclosed herein, may further include “never-exceed” caps 305 & 306. However, the rate cap 301 and burst cap 300 may be dynamically adjusted based on real-time data rate 302 and burst rate 303 information, as discussed further below.

Generally, in embodiments, a method of the invention comprises looking at a short sequence of the current session history of bandwidth data rates 302 and data bursts 303 and determining if they significantly differ from the currently configured network data cap and burst cap settings. If so, the current operating caps 300 and 301 for the session may be lowered or raised, according to the prevailing rates, subject to a “never-exceed” data rate cap 305 and “never-exceed” burst cap 306.

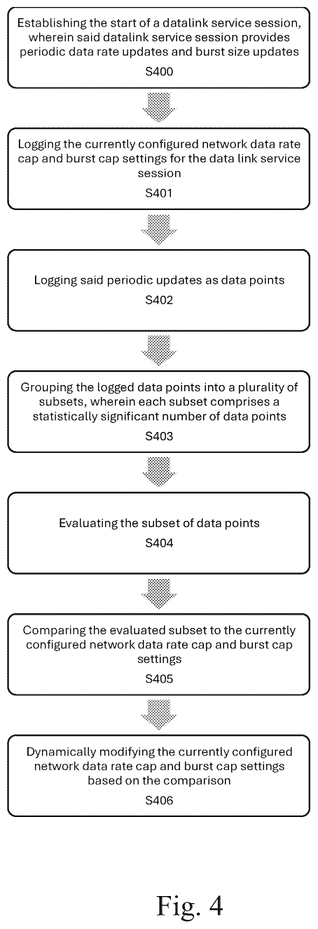

Referring to FIG. 4, a process flowchart of an exemplary method of the present invention is shown. In embodiments, the method comprises the following steps: S400 establishing the start of a datalink service session, wherein said datalink service session provides periodic data rate updates and burst size updates; S401 logging the currently configured network data rate cap and burst cap settings for the data link service session, wherein the currently configured network cap settings comprise a data rate cap 301, a burst cap 300, a never-exceed data rate cap 305, and a never-exceed burst cap 306; S402 logging said periodic updates as data points, in a circular buffer, during use of the data network system in an aircraft; S403 grouping the data points into a plurality of subsets, wherein each subset comprises a statistically significant number of data points; S404 evaluating the subset of data points to arrive at anticipated needed levels of data rate and burst rate, based on the most recent usage of data rate and burst rate by the data link; S405 comparing the anticipated needed levels of data rate and burst rate to the currently configured network data rate cap and burst cap settings; and S406 dynamically modifying the currently configured network data rate cap 301 and burst cap 300 settings based on the anticipated needed levels of data rate and burst rate, such that the network data rate cap 301 and burst cap 300 settings provide adequate bandwidth for the anticipated needed levels of data rate and burst rate. In embodiments, the method further includes measuring, after establishing the datalink service session, multiple samples of the data link service session. Each sample may correspond to a discrete measurement period during which data traffic characteristics are monitored and logged. The samples collectively form a set of samples that are statistically analyzed to determine patterns in bandwidth utilization over time. The comparison step may include evaluating whether the measured data bandwidth rates and data burst rates fall within acceptable ranges relative to the configured network bandwidth cap settings, and determining the magnitude of any deviations from the current settings. The dynamic modification of the bandwidth cap settings may be performed to achieve an acceptable lowest bandwidth value that maintains the desired quality of data communication for the channel while optimizing bandwidth efficiency. This approach may ensure that bandwidth allocation is continuously optimized based on actual usage patterns rather than static predetermined limits, thereby improving overall network resource utilization and user experience. The method may be applied iteratively across multiple channels of the communication system to achieve system-wide bandwidth optimization.

In embodiments, evaluating a subset of data points at step S404 may comprise calculating the average data rate of the subset, calculating a maximum burst value of the subset, calculating an average burst value of the subset, and calculating the standard deviation of the burst values in the subset. Further, more than one subset of data points may be used in the analysis, and the results may be averaged or otherwise combined to arrive at the anticipated needed levels of data rate and burst rate for the data link, while reserving bandwidth for other users of the data link. Any number of subsets of data points may be used, and combined in any manner, and all such numbers of subsets and manner of analyzing such subsets to arrive at the anticipated needed levels of data rate and burst rate for the data link are within the scope of the present invention.

In embodiments, comparing the evaluated subset and dynamically modifying a data rate cap comprises the step of determining whether the average data rate is greater than the data rate cap 301. If the average data rate is greater than the data rate cap 301, the data rate cap may be modified by adjusting the data rate cap 301 to the never-exceed data rate cap 305. If the average data rate is greater than or equal to the current data rate cap (within a predetermined percentage, for example 95+%), but less than the never-exceed cap, the data rate cap may be raised to the average data rate plus a predetermined percentage, for example +5%. If the average data rate is approximately near the current data rate cap (e.g. within 90%-95%), then the current data rate cap may be left unadjusted. If the average data rate is significantly less than the current data rate cap (e.g. less than 90%), then the current data rate cap may be lowered to ~90% of the average data rate, and so on. These values are exemplary in nature, and the system designer may employ any values or rules for adjustment of the data rate cap that are reasonable for the circumstances related to the data link and user equipment in question. For example, some user equipment may be tolerant of short-duration bandwidth issues by using encoding or other techniques, and these systems may have data rate caps set closer to the anticipated usage, and so on.

In embodiments, comparing the evaluated subset and dynamically modifying a burst cap 300 may further comprise the step of determining whether a maximum burst size is greater than the burst cap. If a maximum burst size is greater than the burst cap, then the current burst cap may be set to the never-exceed cap. If a maximum burst size is greater than the current burst cap, current burst cap may be raised to the maximum burst size plus the standard deviation, or some other determined percent, of the bursts. If a maximum burst size is approximately the burst cap size (e.g. approximately within ±5%), the burst cap may be left unchanged. If a maximum burst size is less than the current burst cap, then the current burst cap may be lowered by the standard deviation of the average. Again, these values are exemplary in nature, and the system designer may employ any values or rules for adjustment of the burst rate cap that are reasonable for the circumstances related to the data link and user equipment in question.

In embodiments, the present invention may also identify and predict faults or events in an avionics communication system during a flight. The invention leverages the forecasted network performance to implement actions that enhance the overall user experience. The invention may utilize an artificial intelligence or machine learning-based model that is trained through historical data link performance information. Implementation of the invention can be summarized, generally, in three (3) phases: pre-flight, in-flight, and post-flight.

An aircraft's flight path, or route, can significantly impact SATCOM data network performance due to various factors. For example, and not by way of limitation, the factors may be related to geography, atmospheric conditions, and network infrastructure. Satellite communications rely on satellites placed in geostationary or other earth orbits to provide service coverage. The flight route/plan of a particular aircraft affects which satellites with which it may communicate. Over remote areas like oceans or polar regions, satellite coverage may be sparse, leading to potential interruptions or reduced data rates. As the aircraft progresses along its flight route/plan, it transitions between the coverage beams of different satellites. Frequent handovers, especially in regions with denser satellite coverage, can lead to brief periods of data loss or reduced performance due to the switching process.

Certain air routes, especially those over busy international corridors, experience higher traffic density. This increased load on a satellite network can lead to congestion, affecting data rates and latency. In regions with high aircraft density, the available satellite bandwidth is shared among more aircraft, potentially reducing the data rates for individual aircraft.

For purposes of description of the various functions of the invention related to predictive data link management, a flight path, plan or route (“flight path”, “flight route”, and “flight plan” are being used herein to refer to the physical path an aircraft takes during flight, which may be defined in two-dimensional or three-dimensional space) taken by an aircraft may be broken into three phases: Phase 1, Phase 2, and Phase 3. These defined phases are merely to aid in discussion and are not intended to be limiting on the scope of the invention.

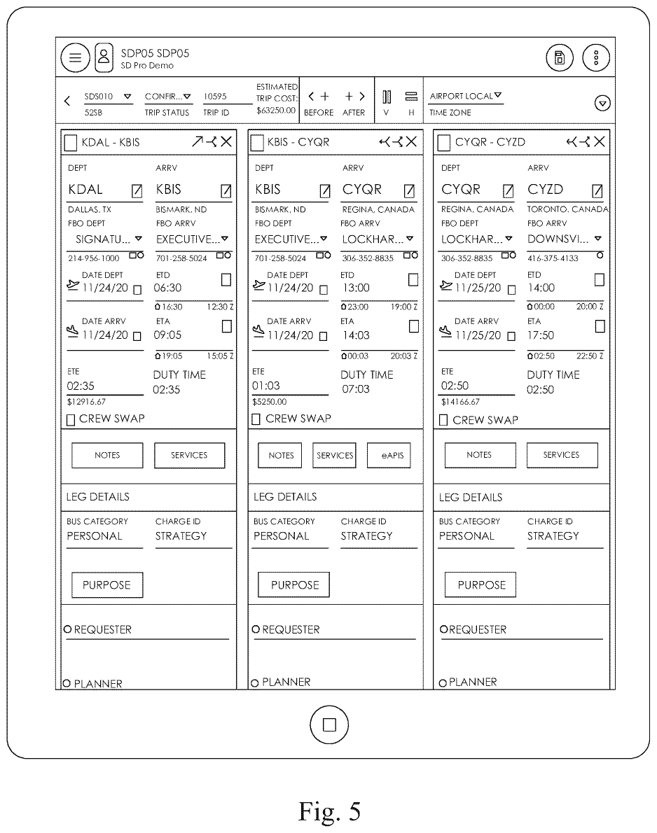

Phase 1 occurs pre-flight, in which the system predicts the performance of a chosen network based on the desired flight route/plan. Referring to FIG. 5, a user interface showing different flight routes (e.g., or other types of vehicle routes) is shown. The flight plan can then be adapted to provide the optimal performance. The performance is determined through a scoring algorithm, discussed below, that combines both the network's quality of service (QoS) and the user's experience (QoE).

Phase 2 occurs in-flight, in which the system anticipates potential events or faults that could degrade network performance in real-time (or near real-time). These may include expected outages, handovers, congestion, equipment failure, and more. Some non-limiting examples of events and faults and their categorizations are:
MBB Handover: Modem data switch attempt and acquisition
BBM Handover: Modem data switch attempt and acquisition
Satellite Handover: Modem data switch attempt and acquisition
Bad MBB Handover: Switch time >1Os
Bad BBM Handover: Switch time >20s
Bad Satellite Handover: Switch time >30s
Overheat issues-Equipment overheating or thermal cycling
Congestion: Congestion Metric
Dynamic Flight: Pitch, Roll, Yaw rate of change
Blockage (Positional): Elevation angle<10, −15<Azimuth angle<15
Blockage (Physical): N/A
RF Performance-Low Signal to Noise Ratio (SNR): SNR more than 2 dB less than expected
RF Performance-Low Elevation Angle: Elevation angle<10
RF Performance-Low Azimuth Angle: −15<Azimuth angle<15
Pipeline Saturation: Max MIR demand for 10-minute period
Video Conferencing/Call Drops: Cloud stats, PAN usage check for application disconnections

The system of the invention can proactively take corrective measures to either rectify the fault or alert the customer about impending satellite communication link outages that cannot be eliminated or avoided. For instance, when an aircraft is equipped with various high speed data services, the system can determine the optimal network at a given time, given a user's usage trends and experience, as well as the network's quality of service. The system can also send notifications to customers to alert them of upcoming outages or handovers. There is also potential to assist with handover decisions to create a more seamless handover experience and reduce switch times.

Phase 3 occurs post-flight, in which the system conducts an analysis categorizing all encountered faults or events. Additionally, it identifies anomalies, which may be faults or events that have not previously occurred. This post-flight assessment contributes to a comprehensive understanding of system behavior, aiding in ongoing improvement efforts and providing valuable insights for future flights. Examples of events and faults include (but are not limited to) congestion, blockage, overheating issues, beam switches, satellite switches, RF performance issues, pipeline saturation, dynamic flight, and so on.

Implementation of systems and methods of the present invention may be accomplished through the application of Artificial Intelligence (AI) & Machine-Leaming (ML) algorithms. These algorithms will undergo training using accumulated LRU and historical flight data spanning several years, such as positional data, aircraft dynamics, equipment controls & status and QoS & QoE indicators. The approach encompasses a combination of traditional algorithms, including clustering, recurrent neural networks and reinforcement learning, for scoring, time series predictions and optimization. Additionally, cutting-edge technologies such as transformer and sequence to sequence networks will be employed for real-time detection.

Systems and methods of the present invention predict the performance of a chosen data network based on the desired flight route. The flight plan, or flight path, can then be adjusted to provide optimal network performance. The predicted network performance is determined through a scoring algorithm that combines both the network's quality of service (QoS) and the user's experience (QoE).

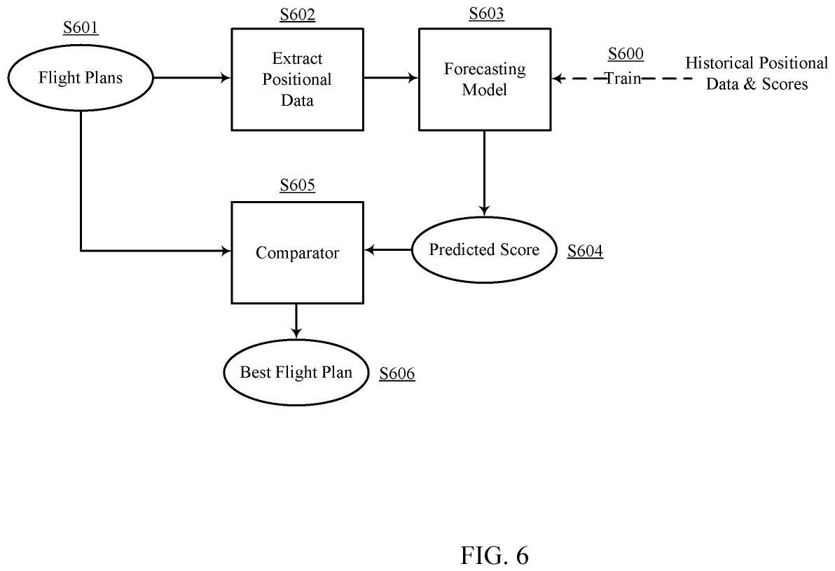

Referring to FIG. 6, a process flowchart for providing a flight plan which would deliver the optimal network performance is shown. Initially, at step S600 one or more forecasting models for generating a predicted score of a flight plan are trained using historical data. In embodiments, this historical data comprises aircraft positional data and the network performance score of the network when the aircraft was at that position. Next, at step S601 one or more flight plans are input into the system. At step S602, expected positional data of an aircraft during a planned flight is extracted from the one or more flight plans. At step S603, the extracted positional data is input to the trained forecasting model. The trained forecasting model then outputs a predicted score at step S604. At step S605, the predicted score of the flight plans input at S601 are run through a comparator. Lastly, the best flight plan of the one or more flight plans is presented at step S606.

Referring to FIGS. 6 & 7, in embodiments the network forecasting model used in steps S603 and S604 may be a recurrent neural network (RNN) model. For example and not meant to be limiting, the RNN model may be a Long short-term memory (LSTM) type or it may be an attention based LSTM type. The RNN model may be iteratively trained using historical data. At every iteration, the error between the predicted score and actual score is calculated. The model error is then used to update the weights of the model. This iterative training process is repeated until the convergence between the predicted score and actual score reach a predetermined margin.

Referring to FIGS. 6 & 8, in some embodiments, the network forecasting model used in steps S603 and S604 may be performed using a K nearest neighbor algorithm (KNN). Using historical data such as positional and scoring data, the distance between specified position and all historical positional data may be calculated. The K nearest points may be selected (the value of K is determined through trial and error). Then, the score of the K nearest points may be averaged to determine the predicted score based on the aircraft's flight route.

Still further, in embodiments, referring to FIGS. 6 & 9, the predicted network performance score in steps S603 & S604 may be performed using a Support Vector Regression (SVR) based model. This model finds the best fit line that maximizes the number of points within the decision boundary.

During Phase 2, in which an aircraft is in-flight, the system anticipates anomalies, potential events, or faults that could degrade network performance in real time. An aspect of the invention is that the system can proactively take corrective measures to either rectify a fault or alert a customer about impending outages that cannot be eliminated.

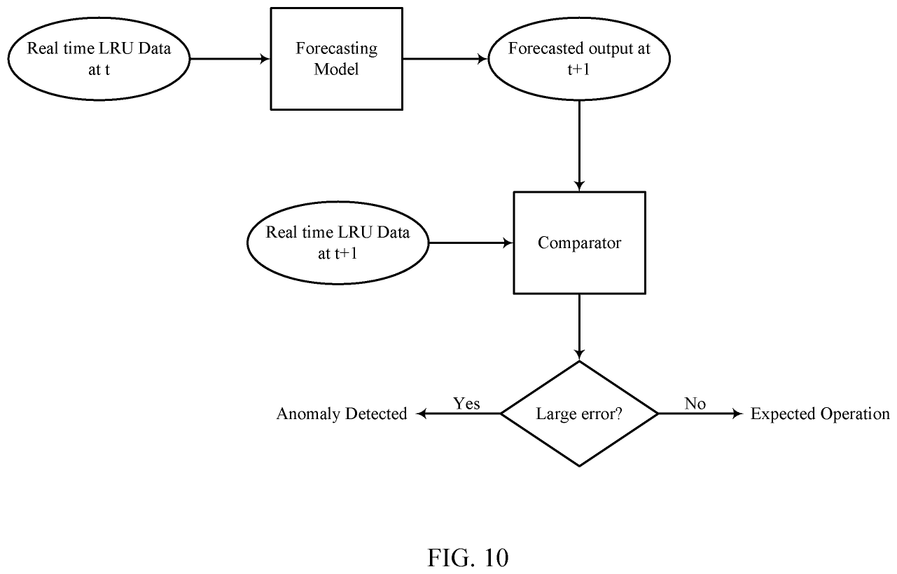

Referring to FIG. 10, the ability to detect anomalies in real-time may be accomplished by comparing the predicted network performance at a time t+1 to the real-time performance at time t+1. If the comparison is greater than a predetermined margin, an indication of an anomaly is presented. If the comparison falls within a predetermined margin, no anomaly is indicated and the operation continues as expected.

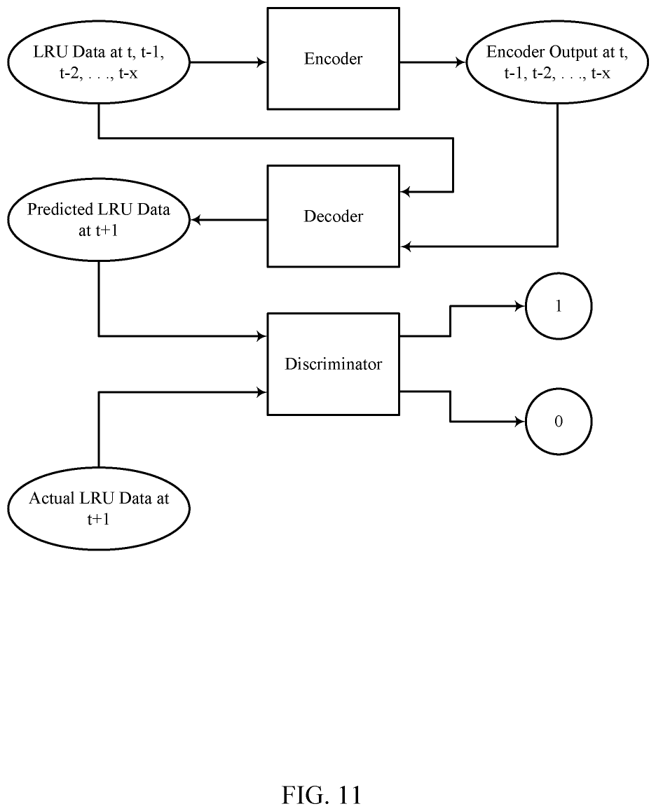

During phase 2, it is crucial to identify any potential deviations from the normal and expected network performance, known as anomalies. Traditional methods for anomaly detection often fail to capture complex patterns in data. Therefore, there is a need for an advanced model that can accurately detect anomalies by learning and understanding the normal data distribution. The ability to detect anomalies in real-time may be accomplished using cutting-edge technologies such as transformers and sequence to sequence (SQ2SQ) forecasting models. Referring to FIG. 11, a SQ2SQ forecasting model consists of an encoder, decoder, and discriminator. Contents of the encoder, decoder and discriminator may vary-for example VAEGAN, attention based VAEGAN, or transformer. The model may be trained through adversarial learning and maps input sequences to output sequences. A time sequence provided by the LRU data may be provided as an input for predicting a future outcome.

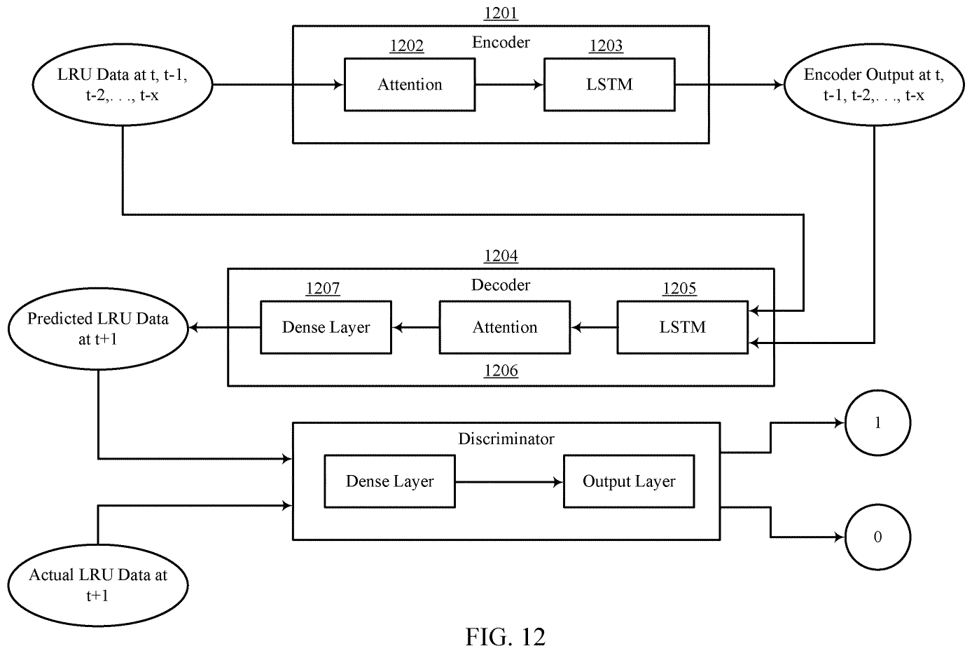

Referring to FIG. 12, a flow chart illustrating real-time detection of an anomaly in network performance using a Variational Autoencoder Generative Adversarial Network (VAEGAN) forecasting model is shown. This forecasting model combines the strengths of Variational Autoencoders (VAEs) and Generative Adversarial Networks (GANs) to effectively identify anomalies by learning a robust representation of normal data and generating realistic data samples. Additionally, the model incorporates attention mechanisms and Long Short-Term Memory (LSTM) layers to capture temporal dependencies and relevant features in the data to perform accurate time-series forecasting and real-time anomaly detection.

In embodiments, the system architecture comprises a Variational Autoencoder (VAE) component, a Generative Adversarial Network (GAN) component, and integration of the VAE and GAN components. The Variational Autoencoder (VAE) Component may comprise an encoder 1201 configured to receive input data, compress it into a lower-dimensional latent space representation, and a decoder 1204. The encoder comprises an Attention Layer 1202 and a LSTM Layer 1203. The Attention Layer 1202 enhances the model's ability to focus on important parts of the input data, improving the representation of relevant features. The LSTM Layer 1203 captures temporal dependencies in sequential data, making the model effective for time-series anomaly detection. The latent space captures the underlying factors of the input data. The VAE ensures that this latent space follows a predefined normal distribution.

The decoder network reconstructs the input data from the latent space representation. The decoder comprises a LSTM Layer 1205, an Attention Layer 1206, and a fully connected output layer (i.e. dense layer) 1207. The LSTM Layer 1205 helps in generating sequences that retail temporal coherence. The Attention Layer 1206 aids in focusing on significant parts of the latent representation during reconstruction. The fully connected output layer 1207 outputs the reconstructed data x′x′x′, closely resembling the original input xxx.

Generative Adversarial Network (GAN) component receives samples from the latent space and generates synthetic data samples. The generator is trained to produce data that is indistinguishable from real data. The discriminator network evaluates the authenticity of data samples, distinguishing between real and generated samples. The discriminator outputs a probability indicating whether a given sample is real or fake.

Integration of VAE and GAN components results in a combined architecture VAEGAN model. The encoder and decoder of the VAE provide a structured latent space, while the GAN discriminator ensures the realism of the generated data. The VAE is trained to minimize the reconstruction loss and the Kullback-Leibler (KL) divergence between the encoded distribution and the prior distribution. Simultaneously, the GAN is trained with an adversarial loss where the generator tries to fool the discriminator, and the discriminator tries to distinguish real data from generated data.

In embodiments, the method for detecting a network performance anomaly in real-time comprises a training phase and a detection phase. In the training phase, the VAEGAN model is trained using normal (non-anomalous) data. The VAE learns to encode and decode the normal data distribution, and the GAN discriminator learns to differentiate between real and generated normal data.

During the detection phase, new data samples are input into the VAEGAN model. The model reconstructs the input data and calculates the reconstruction error by comparing the input data xxx and the reconstructed data x′x′x′. High reconstruction errors indicate that the input data does not conform to the learned normal data distribution, thereby signaling potential anomalies.

Practical Implementation requires collecting and preprocessing normal data samples relevant to the application, such as network data performance. Then normalizing and structuring the data appropriately for input into the VAEGAN model.

Training the VAEGAN model requires initializing and configuring the model with appropriate hyperparameters and training the model on the prepared normal data, optimizing the reconstruction loss and adversarial loss.

Detection of an anomaly occurs by inputting new data samples into the trained VAEGAN model. Computing the reconstruction error for each data sample and flagging data samples with high reconstruction errors as potential anomalies for further investigation.

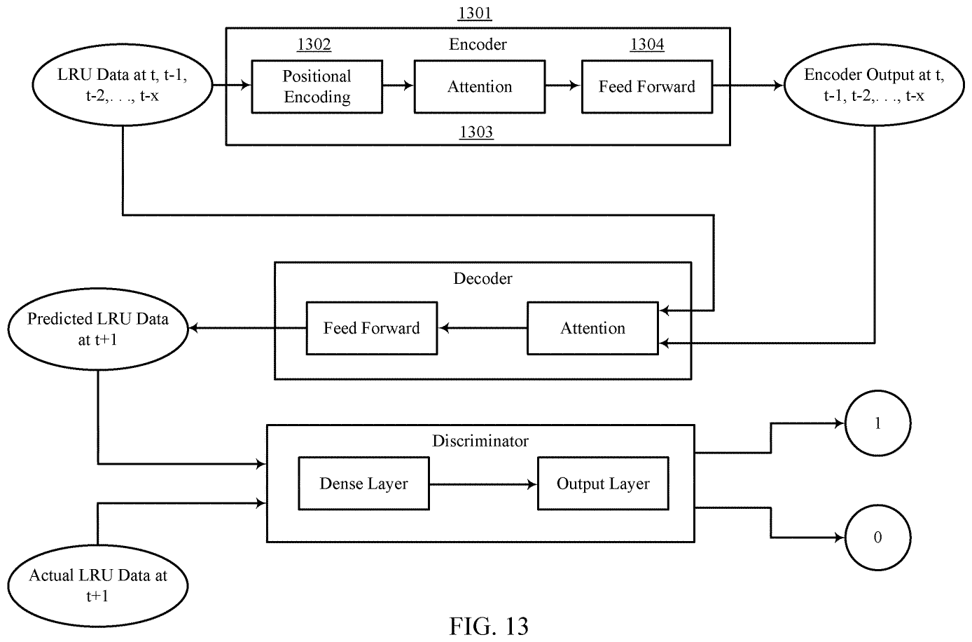

Referring to FIG. 13, a flow chart illustrating real-time detection of an anomaly in network performance using a Transformer forecasting model is shown. In this embodiment, the encoder 1301 doesn't use RNNs-instead, the encoder consists of positional encoding layer 1302, attention layer 1303 and feed forward network 1304. The decoder consisting of an attention layer and feed forward network

Similar to the above described VAEGAN forecasting model (See FIG. 12), the system architecture comprises a Variational Autoencoder (VAE) component, a Generative Adversarial Network (GAN) component, and integration of the VAE and GAN components. The encoder network of the VAE component is configured to receive input data xxx and compress it into a lower-dimensional latent space representation. The encoder comprises a Positional Encoding Layer, an Attention layer, and Feed-Forward Network. The Positional Encoding Layer adds positional information to the input data to retain the order of the sequence, enabling the model to understand the position of elements in the sequence. The Attention layer enhances the model's ability to focus on important parts of the input data, improving the representation of relevant features. The Feed-Forward Network consists of one or more dense layers that process the attended features, enabling complex transformations and feature extraction.

The latent space captures the underlying factors of the input data. The VAE ensures that this latent space follows a predefined normal distribution.

The decoder network reconstructs the input data from the latent space representation. The decoder comprises an Attention Layer and a Feed-Forward Network. The Attention Layer aids in focusing on significant parts of the latent representation during reconstruction. The Feed-Forward Network processes the attended latent features and reconstructs the input data x′x′x′, closely resembling the original input xxx.

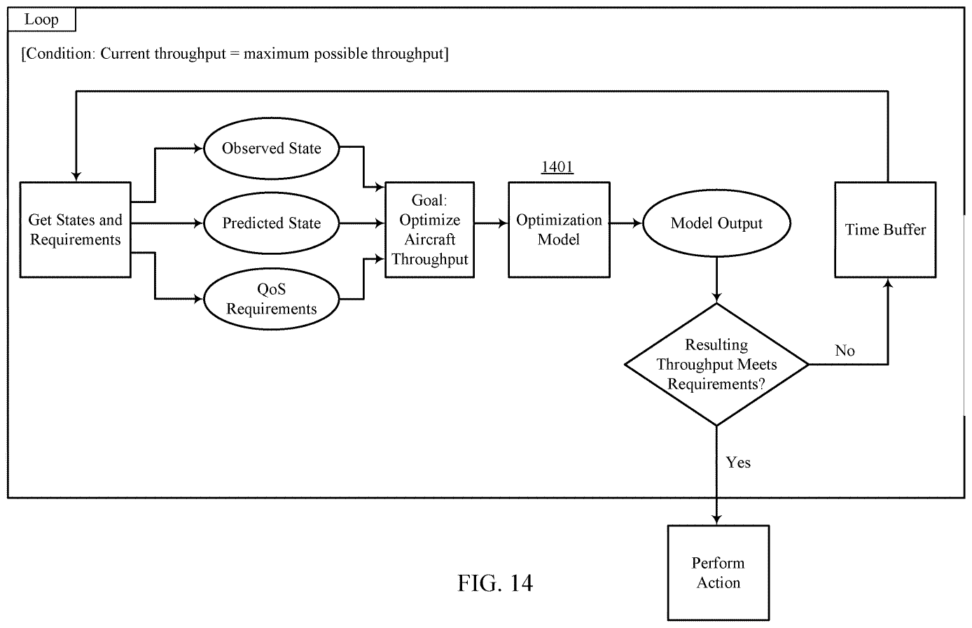

The system and method of the present invention goes beyond mere detection; it leverages the predicted performance to make informed decisions aimed at optimizing the overall user experience. Referring to FIG. 14, a general flow chart for optimizing network data performance during a flight is shown by performing an action. This includes actions such as selecting a network aligning with specified QoS requirements, choosing the most connectivity-optimal flight route, rebooting equipment to address potential equipment failures, or adjusting transmission to prevent equipment overheating.

One of ordinary skill in the art will appreciate that there are numerous models which could be used for optimizing an aircraft's network data throughput. For example, and not meant to be limiting, the Optimization Model 1401 may be implemented using a reinforcement learning model, a deep learning model, gradient-based optimization algorithms, and/or decision trees.

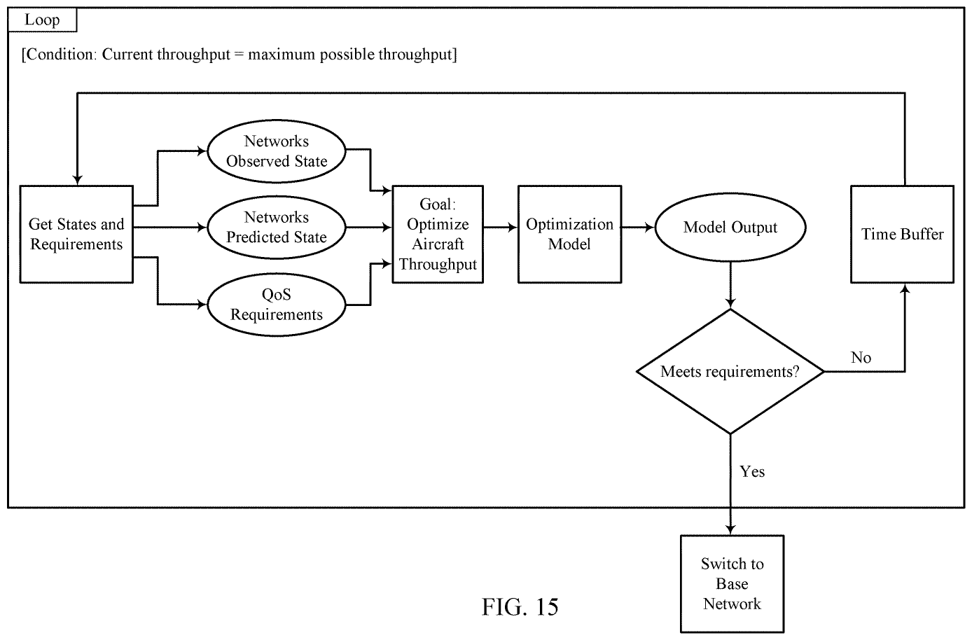

Referring to FIG. 15, a general flow chart for optimizing network data performance during a flight is shown wherein switching to the best network is the action performed as a result of the analysis.

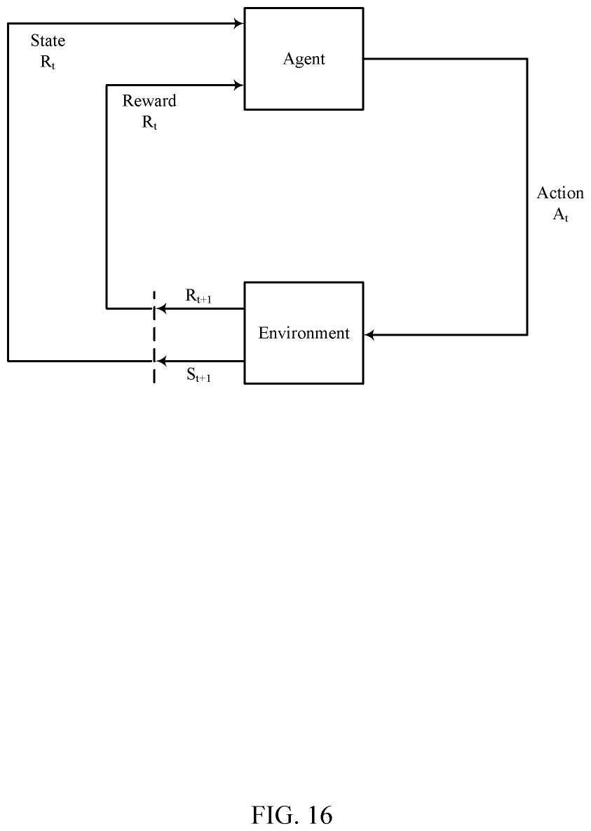

Referring to FIG. 16, a flow chart of an optimization model implemented through reinforcement learning is shown. The agent observes the state of the environment, and takes actions. The goal is to find a suitable action that maximize the total reward. In an exemplary embodiment, the reinforcement learning agent is responsible for selecting network connections based on observed network data speeds and other performance metrics. The environment consists of the available network connections and their respective performance characteristics (e.g., data speeds, latency, signal strength). The state represents the current performance metrics of the available network connections. An action corresponds to the selection of a particular network connection. The reward signal provides feedback to the agent based on the data speed achieved after selecting a network connection. Higher data speeds result in higher rewards.

The reinforcement learning optimization process illustrated in FIG. 16 may be further enhanced through advanced finetuning techniques specifically designed for preflight prediction models. In embodiments, reinforcement learning-based finetuning may be implemented using Group Relative Policy Optimization (GRPO) as the optimization strategy to improve model performance during the preflight phase. This finetuning process may operate by having the model generate candidate performance score sequences for a given flight path, which are then evaluated by a reward model that assesses the quality and accuracy of the predictions. The model parameters may be subsequently updated to favor predictions that maximize the expected reward, thereby improving the overall prediction accuracy and reliability.

The reward shaping mechanism incorporated in this finetuning approach may assign higher rewards for correct predictions under challenging operational conditions, such as low altitude scenarios, handover situations, and low signal-to-noise ratio (SNR) environments. This environmental context-aware reward system may ensure that the model becomes particularly adept at making accurate predictions during the most critical phases of flight operations where network performance prediction is most valuable. The GRPO-based approach may leverage features that are available only during the training phase, allowing the model to learn from comprehensive historical data while maintaining the ability to make predictions using only the limited feature set available during actual preflight planning. This advanced finetuning methodology may enhance the reinforcement learning agent's ability to select optimal network connections and flight routes by improving the underlying prediction models that inform these decisions.

Phase 3 occurs post-flight, in which the system of the present invention conducts an analysis categorizing all encountered faults or events. The system scores the performance of the avionics communication system during the flight by combining QoS and QoE. This post-flight assessment contributes to a comprehensive understanding of system behavior, aiding in ongoing improvement efforts and providing valuable insights for future flights.

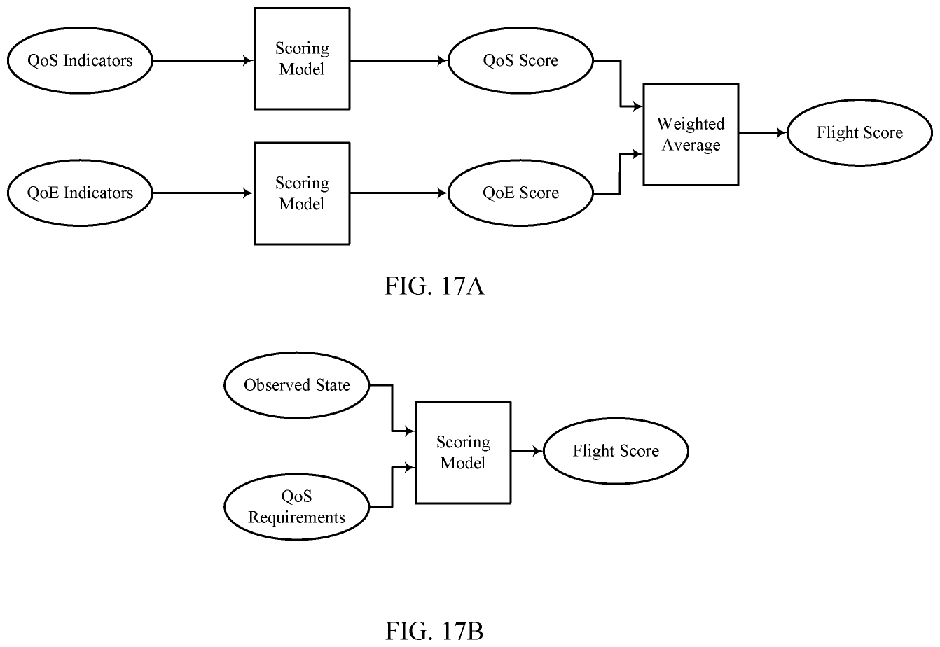

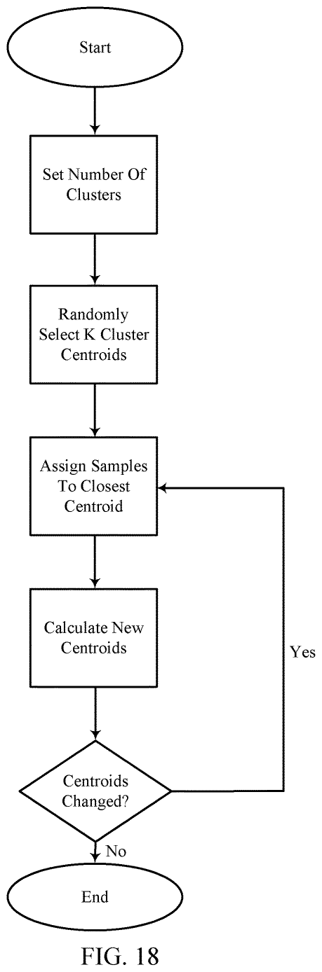

Referring to FIGS. 17A & 17B, exemplary flowcharts for scoring the performance of an avionics communication system during flight is shown. As can be seen, the QoS indicators and QoE indicators can be scored together to determine a flight score. In embodiments, the QoS indicators and QoE indicators can be scored separately and then combined. In embodiments, the scoring models may be implemented using a weighted average or K means clustering, not to be limiting.

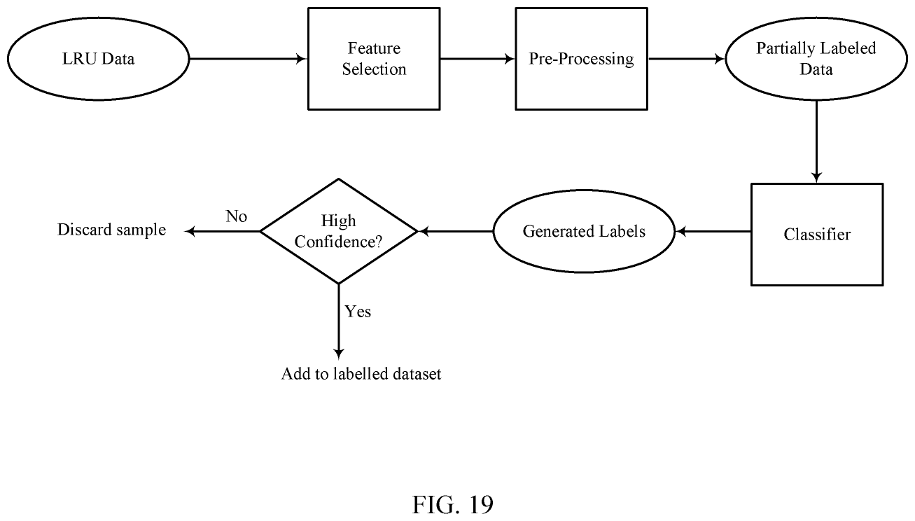

Scoring using K means clustering is shown in FIG. 18. Use unsupervised clustering to score based on QoE and QoS indicators. Set number of clusters to number of scores-for example to score between 1-10 set number of clusters to 10.

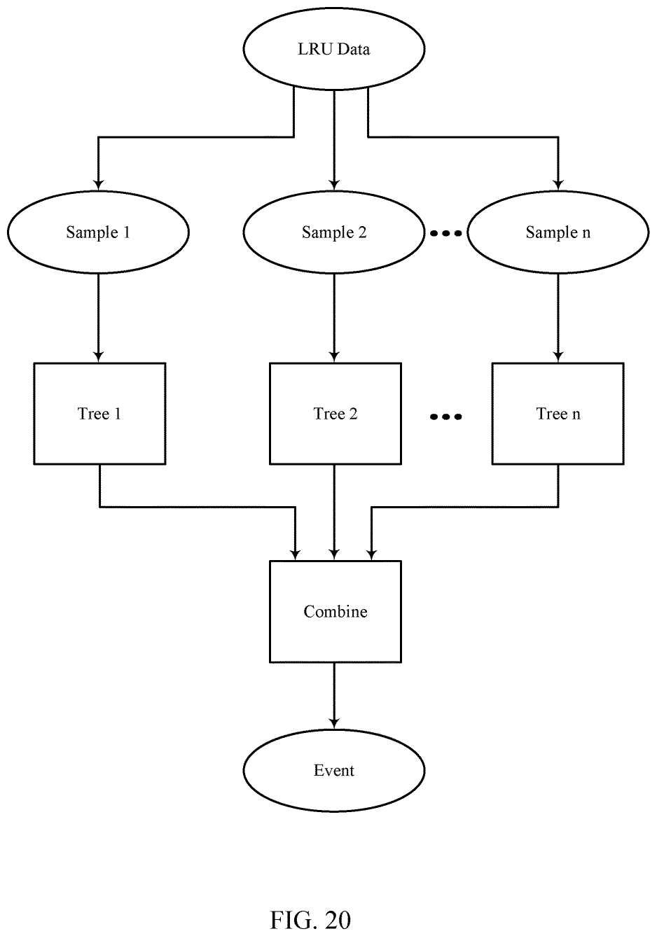

In embodiments, Semi-Supervised Leaming can be used during the analysis in Phase 3. In many real-world scenarios, labeled data is scarce and expensive to obtain, while unlabeled data is abundant and readily available. Semi-supervised learning (SSL) aims to leverage both labeled and unlabeled data to improve learning accuracy. Referring to FIG. 19, an exemplary flowchart for semi-supervised learning for post-flight event classification utilizing partially labelled data is shown. The process begins with a labeled dataset 1901 comprising flight data samples that have been categorized using business logic and predefined thresholds to identify known fault types and events. This labeled dataset is combined with an unlabeled dataset 1902 representing flight data samples that have not been previously classified or fall within “grey areas” outside established classification parameters. The combined partially labeled dataset 1903 is then processed through an ensemble classifier 1904, which may comprise bagging, stacking, or boosting ensemble methods as described herein. Using an ensemble learning classifier to create pseudo-labels improves the process because less data is required for training, resulting in a shorter training time. Also, one can use a python built in confidence interval metric. The classification process described herein may involve the systematic categorization and identification of faults, events, and anomalies that occur during aircraft flight operations within the avionics communication system. Classification, as used herein, may refer to the process of analyzing flight data (e.g., pre-processed flight data) to assign labels or categories to observed network performance conditions, communication disruptions, equipment malfunctions, and operational events, among other examples. This classification may encompass both supervised learning approaches, where the system learns from historical labeled data to identify known fault types, and unsupervised learning methods that can detect previously unknown anomalies or fault patterns that fall outside established thresholds or categories.

The classification system of the present invention may utilize machine learning algorithms, including but not limited to clustering algorithms, neural networks, ensemble methods, and semi-supervised learning techniques, to process and categorize various types of events such as handovers (MBB, BBM, satellite), equipment issues (overheating, RF performance degradation), network conditions (congestion, blockage), and flight dynamics (pitch, roll, yaw variations). The classification output may provide structured identification of each event type, its severity level, duration, and potential impact on communication performance. This systematic classification may enable the system to build comprehensive fault libraries, improve predictive capabilities for future flights, and provide actionable insights for maintenance scheduling, route optimization, and real-time corrective actions during flight operations.

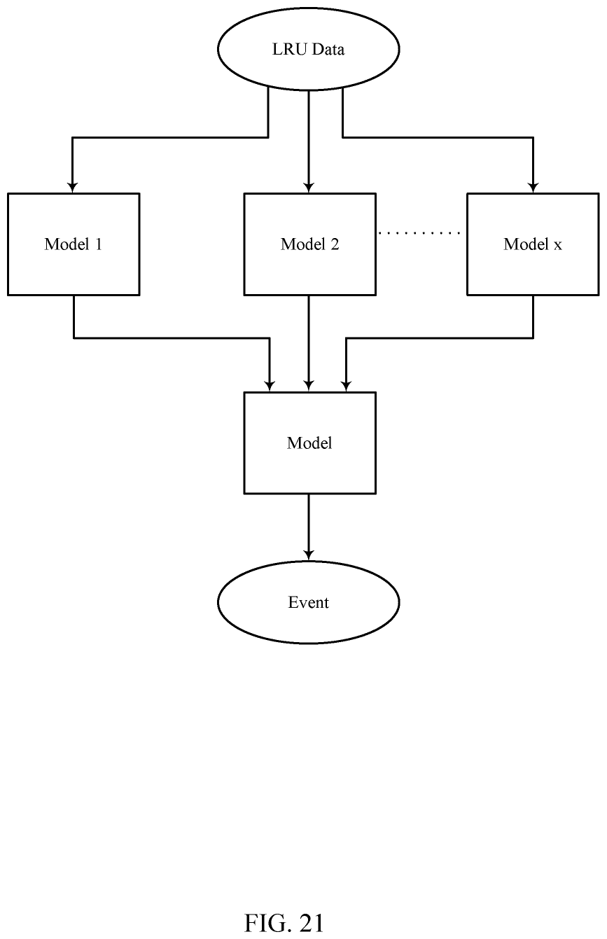

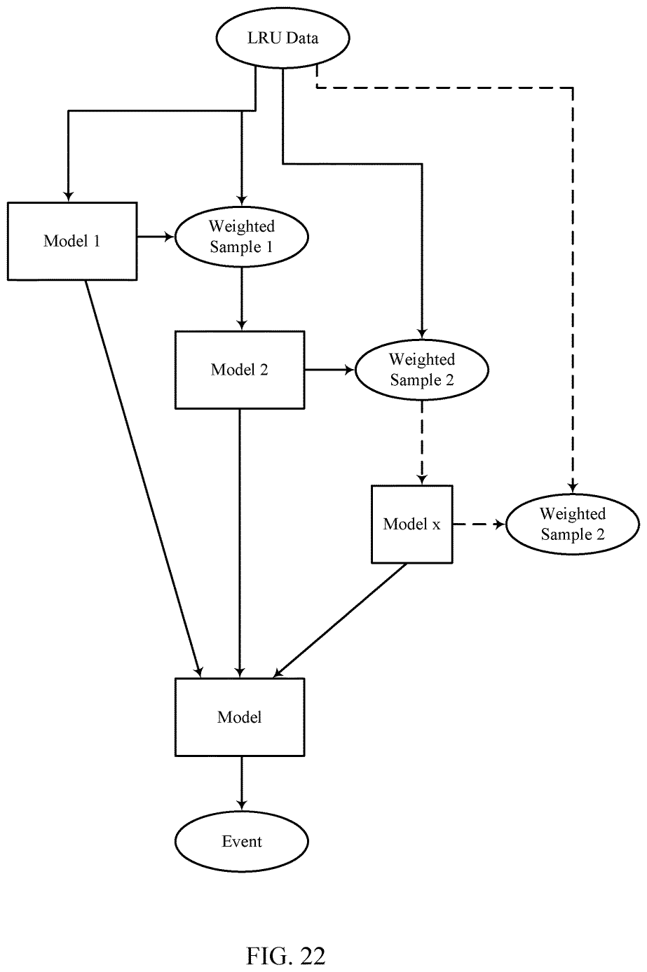

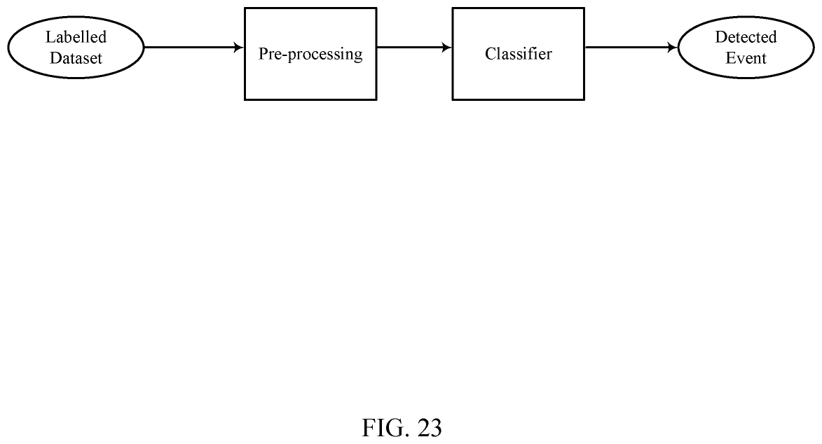

The ensemble classifier may generate pseudo-labels 1905 for the unlabeled data samples, with each pseudo-label being assigned a confidence score indicating the reliability of the classification prediction. A confidence threshold evaluation step 1906 may determine whether each pseudo-label meets a predetermined confidence interval threshold. Pseudo-labels that exceed the confidence threshold may be accepted and added to an expanded labeled dataset 1907, while those falling below the threshold may be rejected. This iterative process may continue until a sufficient quantity of high-confidence pseudo-labels have been generated, creating a comprehensive training dataset that leverages both the original labeled samples and the newly pseudo-labeled samples to improve the classification model's ability to identify faults and events during post-flight analysis. In embodiments, there are three types of ensemble learning classifiers to consider: a Bagging Ensemble (FIG. 20), a Stacking Ensemble (FIG. 21), and/or a Boosting Ensemble (FIG. 22).

Now referring to FIG. 20, shown is a Bagging Ensemble process flowchart for fitting many decision trees on different samples of the same dataset and averaging the predictions. A Bagging Ensemble combines the strengths of ensemble learning and semi-supervised learning to effectively utilize both labeled and unlabeled data, resulting in improved classification performance.

Referring to FIG. 21, shown is a Stacking Ensemble process flowchart. A Stacking Ensemble combines multiple models, often resulting in improved predictive performance compared to using a single model. Stacking is an ensemble learning technique that leverages the strengths of multiple base models and a meta-model to achieve higher accuracy and robustness. Fitting many different models types on the same data and using another model to learn how to best combine the predictions.

Referring to FIG. 22, shown is a Boosting Ensemble process flowchart. A Boosting Ensemble adds ensemble members sequentially to correct predictions made by prior models and output a weighted average of the predictions.

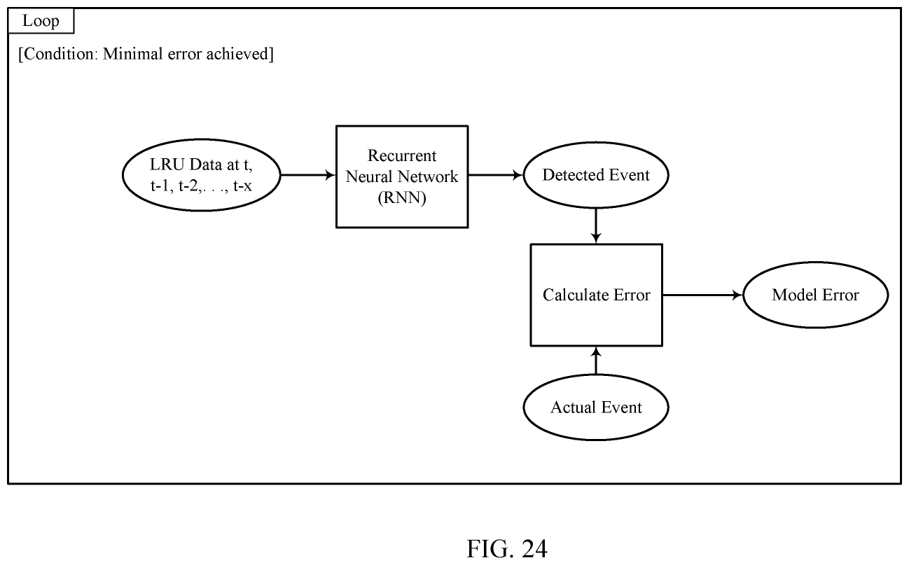

Classification of events that may have occurred during flight may be performed after pseudo-labels are created. Referring to FIG. 23, the labelled dataset can be used to train a classifier to detect events. Classifier types may be RNN (LSTM), K nearest neighbor (KNN) classifier, and/or Support Vector Regression (SVR).

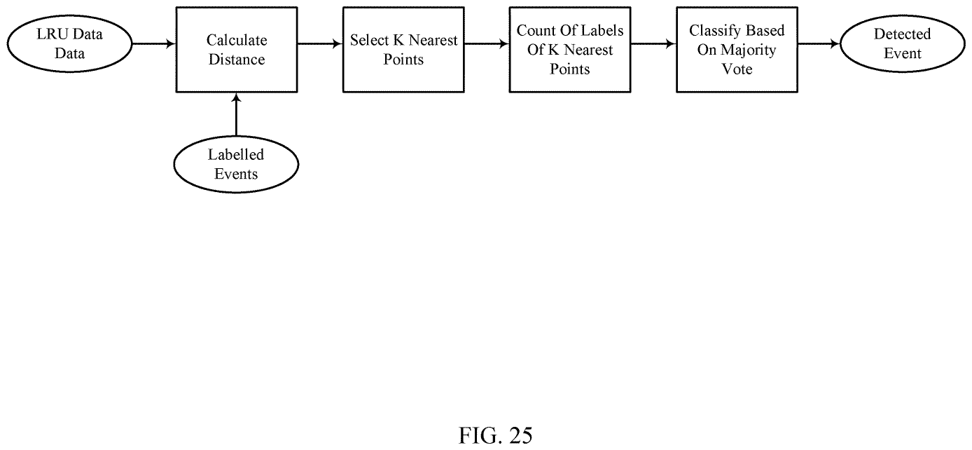

Referring to FIG. 24, a flowchart for event classification using a Recurrent Neural Network (RNN) classifier is shown.

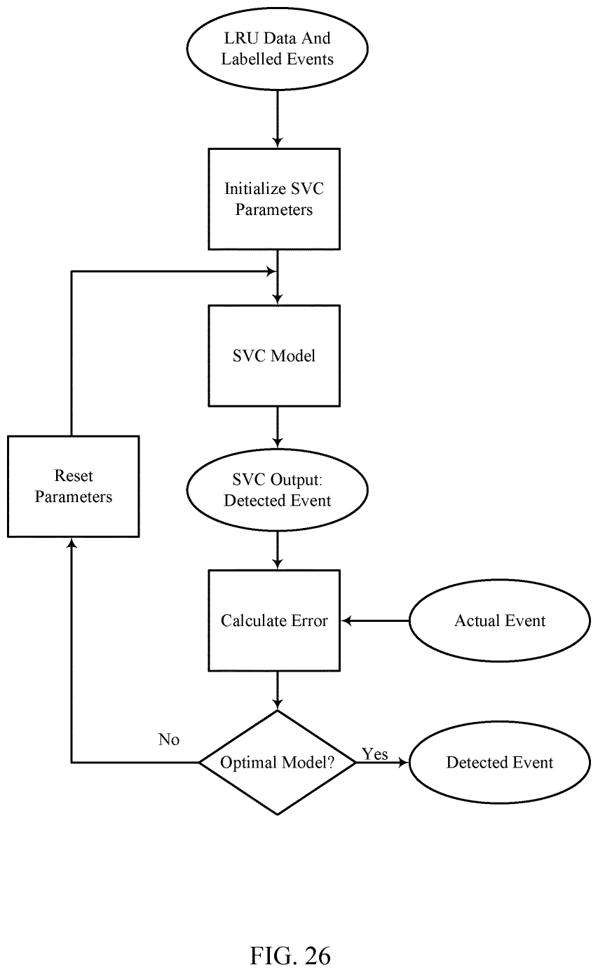

Referring to FIG. 25, a flowchart for event classification using a K Nearest Neighbor (KNN) classifier is shown.

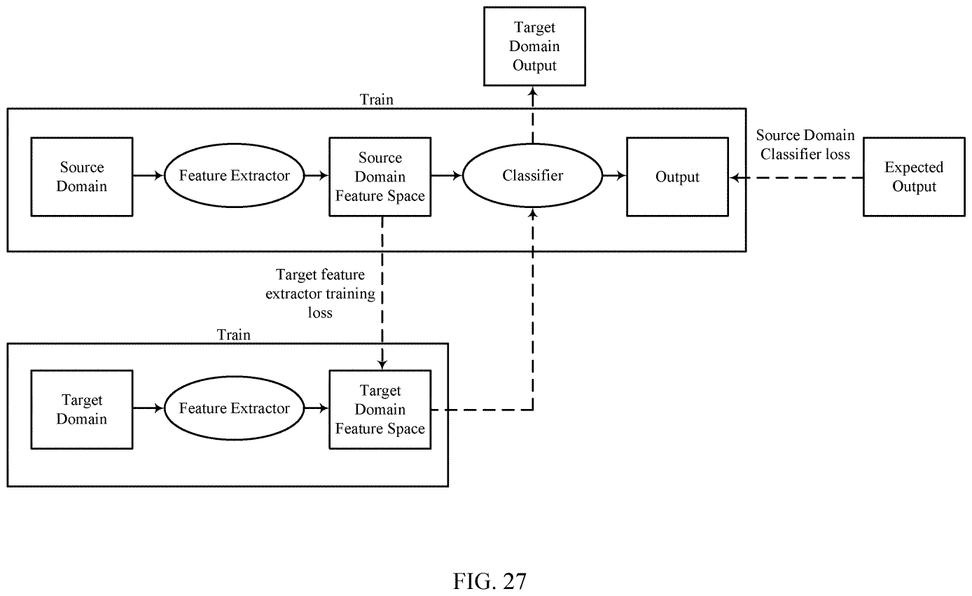

Referring to FIG. 26, a flowchart for event classification using a Support Vector Regression (SVR) classifier is shown. The objective of the algorithm is to find a hyperplane that distinctly classifies that data points.

Still in further embodiments, classification of events during Phase 3 may be implemented using transfer learning. The source domain consists of labelled data—data that was labelled using business logic and pre-defined thresholds. The target domain may contain unlabeled data-unidentified faults that fall within the ‘grey area’ outside of the predefined thresholds. Use of transfer learning provides a fault diagnosis system from a source network trained with labelled data to a target network with unlabeled data, or a small amount of labelled data. This results in a system that can diagnose faults and events with or without needing to label the entire dataset.

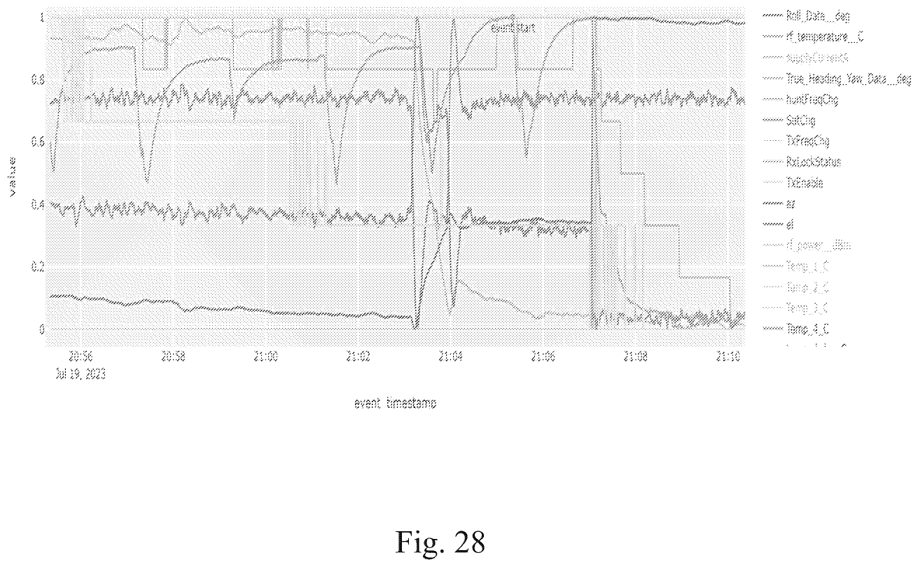

Referring to FIG. 27, the idea is to align the distributions of the source and target data in feature space and then transfer them to the target network. This allows the target domain data to be used with the classifier trained using source domain data. There are three domain adaptation methods: Maximum Mean Discrepancy (MMD), Correlation Alignment (CORAL), and/or Adversarial Domain Adaptation. Maximum Mean Discrepancy looks to minimize the MMD between the target and the source domain. MMD quantifies the difference between two probability distributions. Correlation Alignment (CORAL) looks to align the second order statistics of the source and target domain by matching the covariance matrices. Adversarial Domain Adaptation uses adversarial training to map source domain to target domain feature space. Discriminator is trained to tell the difference between source and target domain. The most important features may be selected for the analysis, and highly correlated features may be removed.

FIG. 28 depicts an exemplary set of features used. In embodiments, the input matrix may contain, for example, fifteen-minute window time stamps of the selected features, for example ten minutes before event start, and five minutes into the event. These parameters are user-determinable based on characteristics of the features being measured and type of event under analysis.

A person of ordinary skill in the art will appreciate that the disclosed invention can extend beyond dynamic network switching, by assisting with beam and satellite handover decisions. By anticipating upcoming events such as congestion, RF performance degradation, and blockage, the system can leverage these predictions to make informed choices regarding the optimal time and beam acquisition. This strategic decision-making process significantly reduces the duration of satellite and beam transitions, resulting in a more seamless connectivity experience for users with fewer service interruptions.

Furthermore, the invention can be expanded to include AI-enabled dynamic bandwidth allocation within the aircraft. While the primary focus is on enhancing overall throughput by optimizing network selection and flight routes, this extension introduces a user-centric approach. Through the development of an AI algorithm, the system can dynamically allocate bandwidth on a per-user basis. This allocation is based on individual usage trends, directing more bandwidth to applications demanding higher data rates, such as streaming and video conferencing.

Although the description provided herein, and the accompanying figures and claims, may contain specific details, they should not be construed as limiting the claims in any way. Other configurations of the described embodiments of the disclosed systems and methods are part of the scope of this disclosure.

It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

What is claimed is:

1. A method, comprising:
establishing a data link service session of a channel within a communication system, the channel corresponding to one or more configured network bandwidth settings;
measuring a plurality of samples of data traffic on the channel to obtain one or more data bandwidth rates and one or more data burst rates for the data traffic, wherein each sample of the plurality of samples corresponds to a respective start time and a respective stop time within the data link service session of the channel;
comparing, based at least in part on the measuring, the one or more data bandwidth rates and the one or more data burst rates to the one or more configured network bandwidth settings; and
adjusting, based at least in part on the comparing and based at least in part on a target quality of data communication for the channel, the one or more configured network bandwidth settings for the channel to an acceptable lowest bandwidth value.

2. The method of claim 1, wherein the one or more configured network bandwidth settings comprise a data rate cap, a burst cap, a never-exceed data rate cap, and a never-exceed burst cap.

3. The method of claim 1, further comprising:
calculating, based at least in part on obtaining the one or more data bandwidth rates and the one or more data burst rates for the data traffic, an average data rate, a maximum burst rate, an average burst rate, a standard deviation of burst rates for the channel, or any combination thereof for the channel.

4. The method of claim 3, wherein comparing the one or more data bandwidth rates and the one or more data burst rates to the one or more configured network bandwidth settings comprises:
comparing the average data rate with the one or more configured network bandwidth settings, wherein the one or more configured network bandwidth settings comprise a never-exceed data rate cap and a data rate cap.

5. The method of claim 4, wherein adjusting the one or more configured network bandwidth settings comprises:
adjusting the data rate cap based at least in part on comparing the average data rate with the data rate cap and the never-exceed data rate cap.

6. The method of claim 4, wherein adjusting the one or more configured network bandwidth settings comprises:
setting the data rate cap to the never-exceed data rate cap based at least in part on the average data rate being greater than the never-exceed data rate cap;
adjusting the data rate cap to be a threshold percentage greater than the average data rate based at least in part on the average data rate being greater than or equal to the data rate cap but less than the never-exceed data rate cap;
maintaining the data rate cap based at least in part on the average data rate being within a threshold range of the data rate cap; or
adjusting the data rate cap to be a threshold percentage less than the average data rate based at least in part on the average data rate being more than a threshold less than the data rate cap.

7. The method of claim 3, wherein comparing the one or more data bandwidth rates and the one or more data burst rates to the one or more configured network bandwidth settings comprises:
comparing the maximum burst rate with the one or more configured network bandwidth settings, wherein the one or more configured network bandwidth settings comprise a burst rate cap, a never-exceed data rate cap, or both.

8. The method of claim 7, wherein adjusting the one or more configured network bandwidth settings comprises:
adjusting the burst rate cap based at least in part on comparing the maximum burst rate with the burst rate cap.

9. The method of claim 7, wherein adjusting the one or more configured network bandwidth settings comprises:
setting the burst rate cap to the never-exceed data rate cap based at least in part on the maximum burst rate being greater than the never-exceed data rate cap;
increasing the burst rate cap by the standard deviation of the burst rates based at least in part on the maximum burst rate being greater than the burst rate cap;
maintaining the burst rate cap based at least in part on the average burst rate being within a threshold range of the burst rate cap; or
lowering the burst rate cap by the standard deviation of the burst rates based at least in part on the maximum burst rate being less than the burst rate cap.

10. A method, comprising:
inputting, to a forecasting model, one or more route plans for one or more candidate routes of a vehicle;
predicting, using the forecasting model and based at least in part on the one or more route plans, one or more network performance scores, each network performance score of the one or more network performance scores indicating a respective predicted level of connectivity in a data network on the vehicle during a respective route plan of the one or more route plans;
outputting, via a user interface, the one or more network performance scores; and
receiving, via the user interface, a selection of an optimal route plan from among the one or more route plans that optimizes in-route network connectivity based at least in part on the one or more network performance scores.

11. The method of claim 10, wherein each route plan of the one or more route plans indicates a respective physical path of the vehicle from an origin to a destination.

12. The method of claim 10, wherein each network performance score of the one or more network performance scores is based at least in part on predicted radio frequency performance during the respective route plan, one or more predicted blockages during the respective route plan, congestion metrics associated with the respective route plan, dynamic flight metrics associated with the respective route plan, or any combination thereof.

13. The method of claim 10, further comprising:
training, using training data, the forecasting model to predict the one or more network performance scores of the data network on the vehicle based at least in part on a route of the vehicle.

14. The method of claim 10, wherein the forecasting model comprises a Recurrent Neural Network-based forecasting model.

15. The method of claim 10, wherein the forecasting model comprises a K nearest neighbor algorithm-based forecasting model.

16. The method of claim 10, wherein the forecasting model comprises a support vector regression-based forecasting model.

17. A method, comprising:
processing, after a flight is complete, data indicative of one or more events that occurred during the flight;
classifying, in accordance with one or more classification models, the data into one or more categories; and
scoring, based at least in part on classifying the data, a performance of an avionics communication system during the flight.

18. The method of claim 17, further comprising:
generating, based at least in part on classifying the data, a quality of service score and a quality of experience score for the avionics communication system during the flight, wherein scoring the performance is based at least in part on a combination of the quality of service score and the quality of experience score.

19. The method of claim 18, further comprising:
applying a semi-supervised learning process to generate one or more pseudo-labels for unlabeled flight data;
combining a labeled dataset with a second dataset including the one or more pseudo-labels to create a training dataset; and
training a classification model based at least in part on the training dataset, wherein classifying the data into the one or more categories is based at least in part on the classification model.

20. The method of claim 19, wherein the classification model comprises one of a bagging ensemble classifier, a stacking ensemble classifier, or a boosting ensemble classifier.
